(19) United States
(12) Patent Application Publication
(10) Pub. No.: US 2019/0317299 A1
(43) Pub. Date: Oct. 17, 2019

(54) TELECONVERTER LENS AND ELECTRONIC DEVICE INCLUDING SAME

(71) Applicant: Samsung Electronics Co., Ltd., Gyeonggi-do (KR)

(72) Inventor: Chang-keun KIM, Gyeonggi-do (KR)

(21) Appl. No.: 16/468,726

(22) PCT Filed: Dec. 15, 2017
(86) PCT No.: PCT/KR2017/014801

§ 371 Date: Jun. 12, 2019

(30) Foreign Application Priority Data
Dec. 26, 2016 (KR) 10-2016-0179316

(51) Int. Cl. G02B 13/00; G02B 9/34

(52) U.S. Cl. CPC G02B 13/004; G02B 13/006; G02B 9/34

(57) ABSTRACT

A tele-converter lens and an electronic device are provided. The tele-converter lens mounted at an object side of a main photographing lens includes: a first lens having a positive refractive power; a second lens having a refractive power and having at least one aspherical surface; and at least one lens having a refractive power, wherein the first lens, the second lens, and the at least one lens are sequentially arranged from the object side toward the main photographing lens.

### TECHNICAL FIELD

The present disclosure relates to a tele-converter lens and an electronic device including the tele-converter lens, for example, a miniaturized tele-converter lens without optical performance degradation and an electronic device including the miniaturized tele-converter lens.

### BACKGROUND ART

The variety of services and additional functions provided by electronic devices are gradually expanding. An electronic device, for example, a mobile device or a user device, may provide various services through various sensor modules. An electronic device may provide a multimedia service, for example, a photo service or a video service. As the use of electronic devices increases, the use of cameras functionally linked with electronic devices is also increasing. The camera performance and/or resolution of electronic devices are being improved according to the demand of users. With cameras of electronic devices, pictures of various landscapes, people, or self-shots may be taken. Such multimedia, e.g., pictures or videos, may be shared on social network sites or other media.

As semiconductors and display technology have improved, various camera lenses for mobile devices, e.g., from low resolution to high resolution, from small-sized sensor format to large-sized sensor format, for example, from a ⅛″ sensor to a ½″ sensor, and from a telephoto lens to an ultra-wide-angle lens, have been developed.

Furthermore, in accordance with the demand of professional-grade consumers, the demand for a converter lens which is additionally attached to a main photographing lens to change the focal length and the angle of view of an entire optical system has increased. It is difficult to correct the chromatic aberration of magnification and the curvature of field with such a converter lens, and a design capable of correcting an aberration with a miniaturized structure is required.

### DESCRIPTION OF EMBODIMENTS

### Technical Problem

Deterioration of the optical performance of the entire optical system may be caused by a converter lens mounted on a main photographing lens. For example, it is difficult to correct the chromatic aberration of magnification caused by the converter lens, and as an entrance pupil of the main photographing lens is close to the converter lens, curvature of field occurs and the performance of a peripheral portion deteriorates. Accordingly, it is necessary to design a converter lens which is miniaturized and capable of easily controlling an aberration.

Various embodiments may provide a tele-converter lens mounted at an object side of the main photographing lens, which may reduce the overall size of the optical system by reducing the distance between lenses and may perform various aberration corrections.

Various embodiments may provide an electronic device that includes the tele-converter lens.

### Solution to Problem

According to an aspect of an embodiment, a tele-converter lens mounted at an object side of a main photographing lens includes: a first lens having a positive refractive power; a second lens having a refractive power and having at least one aspherical surface; and at least one lens having a refractive power, wherein the first lens, the second lens, and the at least one lens are sequentially arranged from the object side toward the main photographing lens.

According to an aspect of another embodiment, an electronic device includes: a photographing lens including at least one lens; a tele-converter lens mounted at an object side of the photographing lens, the tele-converter lens including a first lens having a positive refractive power, a second lens having a refractive power and having at least one aspherical surface, and at least one lens having a refractive power, wherein the first lens, the second lens, and the at least one lens are sequentially arranged from the object side toward the photographing lens; and an image sensor configured to convert an optical image formed by an optical system including the tele-converter lens and the photographing lens into an electric signal.

### Advantageous Effects of Disclosure

A tele-converter lens according to various embodiments may realize an optical system having an increased focal length as the tele-converter lens is mounted at an object side of a main photographing lens, and may facilitate aberration correction while reducing the size of the outer diameter of the optical system.

The optical system after the tele-converter lens according to various embodiments is mounted on the main photographing lens may also maintain optical performance such as resolution and brightness (F number) of the main photographing lens.

Furthermore, an electronic device including the tele-converter lens according to various embodiments may photograph an object at a farther distance with high performance, as compared to before the tele-converter lens is mounted in the electronic device.

### BRIEF DESCRIPTION OF DRAWINGS

FIG. 1 is a diagram illustrating a tele-converter lens of a first numerical example, located at object side of a main photographing lens, according to various embodiments.

FIG. 2 illustrates longitudinal spherical aberration, astigmatism, and distortion of the tele-converter lens of the first numerical example, according to various embodiments.

FIG. 3 illustrates transverse chromatic aberration of the tele-converter lens of the first numerical example, according to various embodiments.

FIG. 4 is a diagram illustrating a tele-converter lens of a second numerical example, located at an object side of a main photographing lens, according to various embodiments.

FIG. 5 illustrates longitudinal spherical aberration, astigmatism, and distortion of the tele-converter lens of the second numerical example, according to various embodiments.

FIG. 6 illustrates transverse chromatic aberration of the tele-converter lens of the second numerical example, according to various embodiments.

FIG. 7 is a diagram illustrating a tele-converter lens of a third numerical example, located at object side of a main photographing lens, according to various embodiments.

FIG. 8 illustrates longitudinal spherical aberration, astigmatism, and distortion of the tele-converter lens of the third numerical example, according to various embodiments.

FIG. 9 illustrates transverse chromatic aberration of the tele-converter lens of the third numerical example, according to various embodiments.

FIG. 10 is a diagram illustrating an example of an electronic device including a tele-converter lens according to various embodiments.

FIG. 11 is a diagram illustrating a network environment system according to various embodiments.

FIG. 12 is a block diagram of an electronic device according to various embodiments.

### MODE OF DISCLOSURE

Hereinafter, one or more embodiments of the present disclosure will be described below with reference to accompanying drawings. However, the techniques disclosed in the present disclosure are not limited to a certain embodiment, but should be appreciated to include various modifications, equivalents, and/or alternatives of the embodiments. Regarding the description of the drawings, like reference numerals may be used for like components.

It will be further understood that the terms “include” and/or “have,” when used in this specification, specify the presence of stated features, integers, steps, operations, elements, and/or components, but do not preclude the presence or addition of one or more other features, integers, steps, operations, elements, components, and/or groups thereof.

As used herein, the term “A or B”, “at least one of A and/or B”, or “one or more of A and/or B” includes any and all combinations of one or more of the associated listed items. For examples, “A or B”, “at least one of A and B”, “at least one of A or B” each may include (1) at least one A, or include (2) at least one B, or include (3) both at least one A and at least one B.

Ordinal numbers as herein used, such as “first”, “second”, etc., may modify various components of various embodiments, but do not limit those components. For example, these terms do not limit the order and/or importance of the components. These terms are only used to distinguish one component from another. For example, a first user device and a second user device are different user devices from each other. For example, according to various embodiments of the present disclosure, a first component may be denoted a second component, and vice versa without departing from the scope of the present disclosure.

When a component (e.g., a first component) is “(operatively or communicatively) connected to or coupled to” another component (a second component), the component may be directly connected or coupled to the other component, or other component(s) (e.g., a third component) may intervene therebetween. In contrast, when a component (e.g., a first component) is directly “connected to” or “directly coupled to” another component (e.g., a second component), no other intervening components (e.g., a third component) may intervene therebetween.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms as used in various embodiments of the present disclosure are merely for the purpose of describing particular embodiments and are not intended to limit the present disclosure to the various embodiments. As used herein, the singular forms are intended to include the plural forms as well, unless the context clearly indicates otherwise. Unless defined otherwise, all terms used herein, including technical terms and scientific terms, have the same meaning as commonly understood by a person of ordinary skill in the art to which various embodiments of the present disclosure pertain. Such terms as those defined in a generally used dictionary are to be interpreted to have the meanings equal to the contextual meanings in the relevant field of art, and are not to be interpreted to have ideal or excessively formal meanings unless clearly defined in the present disclosure. In some cases, even the term defined in the disclosure should not be interpreted to exclude embodiments of the disclosure.

An electronic device according to various embodiments of the disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include, for example, at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit), or the like.

According to some example embodiments, the electronic device may, for example, be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another example embodiment, the electronic device may include, for example, at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some example embodiments, the electronic device may include, for example, at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the disclosure may, for example, be a combination of one or more of the aforementioned various devices. The electronic device according to some example embodiments of the disclosure may be a flexible device, or the like. Further, the electronic device according to an example embodiment of the disclosure is not limited to the aforementioned devices, and may include a new electronic device according to the development of technology.

An electronic device according to various embodiments will be described with reference to the accompanying drawings. As used herein, the term “user” may indicate a person who uses an electronic device or a device (e.g., an artificial intelligence electronic device) that uses an electronic device.

Hereinafter, a tele-converter lens and an apparatus including the tele-converter lens according to various embodiments will be described with reference to accompanying drawings.

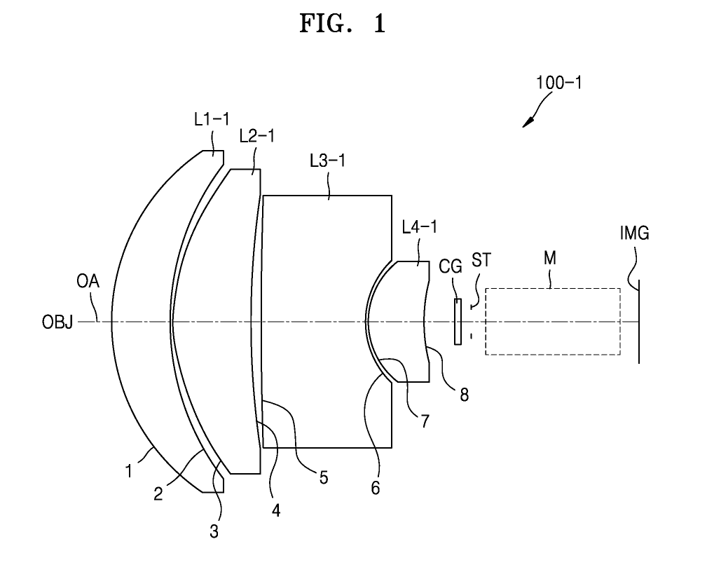

FIG. 1 is a diagram illustrating a tele-converter lens 100-1 of a first numerical example, located at an object side OBJ of a main photographing lens M, according to various embodiments.

Hereinafter, when components of each lens are described, an image side may denote a direction indicating an image plane IMG in which an image is focused and the object side OBJ may denote a direction indicating an object. In addition, an “object side surface” of a lens denotes a lens surface toward an object based on an optical axis OA, that is, a left surface of a lens in the drawings, and an “image side surface” of a lens denotes a lens surface towards the image plane IMG based on the optical axis OA, that is, a right surface of a lens in the drawings. The image plane IMG may be, for example, an imaging device surface or an image sensor surface. An image sensor may include, for example, a sensor such as a complementary metal oxide semiconductor (CMOS) image sensor or a charge coupled device (CCD). The image sensor is not limited thereto, for example, may be a device converting an image of an object into an electric image signal.

The tele-converter lens 100-1 according to various embodiments is an afocal optical system located at the object side OBJ of the main photographing lens M and may provide an optical system capable of photographing at a magnification higher than that of the main photographing lens M.

The tele-converter lens 100-1 according to various embodiments may include a first lens L1-1, a second lens L2-1, and one or more lenses, which are sequentially arranged from the object side OBJ toward the main photographing lens M.

The first lens L1-1 may be a lens having a positive refractive power. The first lens L1-1 may have a meniscus shape of which object side surface is convex.

The second lens L2-1 may have a positive refractive power, and at least one surface of the second lens L2-1 may be an aspherical surface. The use of the aspherical surface may facilitate correcting a chromatic aberration caused by the tele-converter lens 100-1 and may make it possible to reduce peripheral portion performance deterioration due to the curvature of field which appears when an entrance pupil of the main photographing lens M is close to the tele-converter lens 100-1.

One surface of the second lens L2-1 may be an aspherical surface, or both surfaces of the second lens L2-1 may be aspherical surfaces. The second lens L2-1 may have a meniscus shape of which object side surface is convex. The second lens L2-1 may include a plastic resin material. When a plastic material is used, the formation of an aspherical surface may be easier than when a glass material is used.

The tele-converter lens 100-1 may further include a third lens L3-1 having a negative refractive power and a fourth lens L4-1 having a positive refractive power.

The third lens L3-1 may have a concave surface toward the main photographing lens M and the fourth lens L4-1 may have a convex surface toward the object side OBJ. It is possible to reduce the distance between the third lens L3-1 and the fourth lens L4-1 by the shapes of the third lens L3-1 and the fourth lens L4-1.

The main photographing lens M may include at least one lens to form an image of an object on the image plane IMG. An optical system including the main photographing lens M and the tele-converter lens 100-1 may realize a focal length longer than the focal length of the main photographing lens M.

A cover glass CG and an aperture stop ST may be arranged between the main photographing lens M and the tele-converter lens 100-1.

The cover glass CG may be provided to protect the main photographing lens M. The cover glass CG may be located on the outer surface of an electronic device having the main photographing lens M.

The aperture stop ST may adjust the diameter of a light beam, and may include, for example, an opening stop, a variable stop, or a mask type stop.

At least one optical element (not shown) may be provided between the main photographing lens M and the image plane IMG. The least one optical element may be, for example, a low pass filter or an infrared (IR)-cut filter.

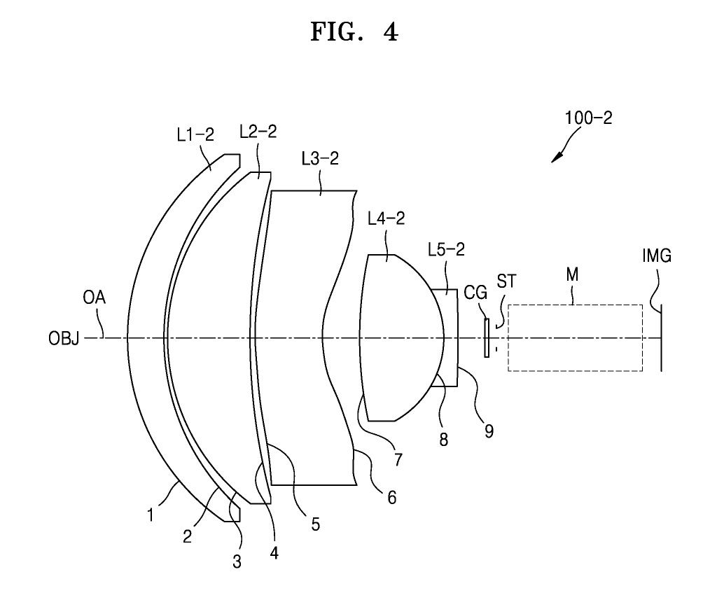

FIG. 4 is a diagram illustrating a tele-converter lens 100-2 of a second numerical example, located at an object side OBJ of a main photographing lens M, according to various embodiments.

According to various embodiments, the tele-converter lens 100-2 may include a first lens L1-2, a second lens L2-2, and one or more lenses, which are sequentially arranged from the object side OBJ toward the main photographing lens M.

The first lens L1-2 may be a lens having a positive refractive power. The first lens L1-2 may have a meniscus shape of which object side surface is convex.

The second lens L2-2 may have a positive refractive power, and at least one surface of the second lens L2-2 may be an aspherical surface. The use of the aspherical surface may facilitate correcting a chromatic aberration caused by the tele-converter lens 100-2 and may make it possible to reduce peripheral portion performance deterioration due to the curvature of field which appears when an entrance pupil of the main photographing lens M is close to the tele-converter lens 100-2.

One surface of the second lens L2-2 may be an aspherical surface, or both surfaces of the second lens L2-2 may be aspherical surfaces. The second lens L2-2 may have a meniscus shape of which object side surface is convex. The second lens L2-2 may include a plastic resin material.

The tele-converter lens 100-2 may further include a third lens L3-2 having a negative refractive power, a fourth lens L4-2 having a positive refractive power, and a fifth lens L5-2 having a negative refractive power.

The third lens L3-2 may have a concave surface toward the main photographing lens M. At least one surface of the third lens L3-2 may be an aspherical surface, or both surfaces of the third lens L3-2 may be aspherical surfaces. The third lens L3-2 may have a shape in which the negative refractive power becomes weaker from a central portion toward a peripheral portion.

The fourth lens L4-2 may have a convex surface toward the main photographing lens M, and may have a biconvex shape.

The object side surface of the fifth lens L5-2 may be concave. That is, the fifth lens L5-2 may have a concave surface toward the object side OBJ. The fourth lens L4-2 and the fifth lens L5-2 may be cemented to each other to form a cemented lens.

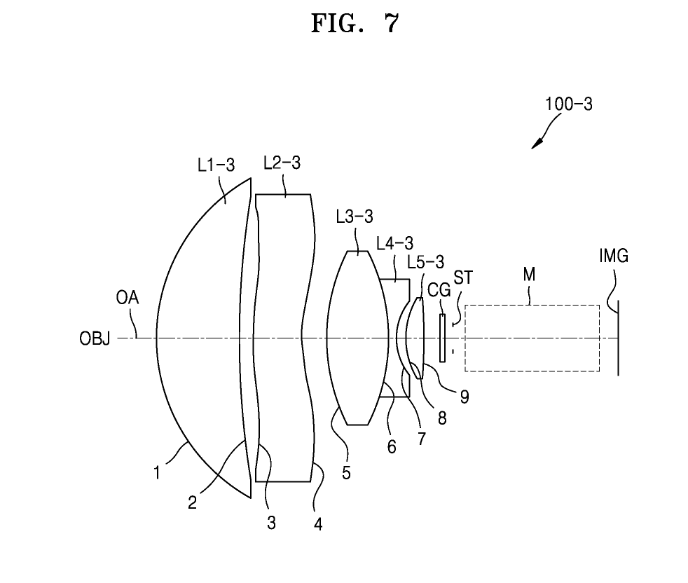

FIG. 7 is a diagram illustrating a tele-converter lens 100-3 of a third numerical example, located at an object side OBJ of a main photographing lens M, according to various embodiments.

According to various embodiments, the tele-converter lens 100-3 may include a first lens L1-3, a second lens L2-3, and one or more lenses, which are sequentially arranged from the object side OBJ toward the main photographing lens M.

The first lens L1-3 may be a lens having a positive refractive power. The first lens L1-3 may have a meniscus shape of which object side surface is convex.

The second lens L2-3 may have a positive refractive power, and at least one surface of the second lens L2-3 may be an aspherical surface. The use of the aspherical surface may facilitate correcting a chromatic aberration caused by the tele-converter lens 100-3 and may make it possible to reduce peripheral portion performance deterioration due to the curvature of field which appears when an entrance pupil of the main photographing lens M is close to the tele-converter lens 100-3.

One surface of the second lens L2-3 may be an aspherical surface, or both surfaces of the second lens L2-3 may be aspherical surfaces. The second lens L2-3 may include a plastic resin material. The second lens L2-3 may have a shape in which a central portion of the object side surface thereof is convex and a central portion of the main photographing lens side surface thereof is concave.

The tele-converter lens 100-3 may further include a third lens L3-3 having a positive refractive power, a fourth lens L4-3 having a negative refractive power, and a fifth lens L5-3 having a positive refractive power.

The object side surface of the third lens L3-3 may have a convex shape. The third lens L3-3 may have a biconvex shape.

The object side surface of the fourth lens L4-3 may have a concave shape. The fourth lens L4-3 may have a biconcave shape.

The third lens L3-3 and the fourth lens L4-3 may be cemented to each other to form a cemented lens.

The object side surface of the fifth lens L5-3 may have a convex shape. The fifth lens L5-3 may have a biconvex shape.

The tele-converter lenses 100-1, 100-2, and 100-3 according to the above-described various embodiments reduces the distance between lenses to suppress an increase in the size of a lens located at the object side OBJ, thereby making an optical system compact. In addition, the tele-converter lenses 100-1, 100-2, and 100-3 suitably adopt as an aspherical surface to reduce the curvature of field that may occur when the tele-converter lenses 100-1, 100-2, and 100-3 are mounted on the main photographing lens M.

The tele-converter lens 100-1 according to various embodiments may satisfy condition 1-1. The following conditions will be described with reference to the tele-converter lens 100-1 according to the first numerical example shown in FIG. 1. However, the following conditions may be equally applied to other embodiments.

1.5<TT/1stY<2.0 (1-1)

Here, TT denotes the total thickness on an optical axis OA of the tele-converter lens 100-1 and 1 stY denotes the effective diameter of the first lens L1-1.

Condition 1-1 represents limiting the ratio of the total length of the tele-converter lens 100-1 to the effective diameter of the first lens L1-1. The center thickness on the optical axis OA of the tele-converter lens 100-1 and the effective radius of a first lens are made small, thereby enabling miniaturization. In addition, when the tele-converter lens 100-1 is mounted at the object side of the main photographing lens M, the phenomenon of light beam cutting (i.e., vignetting) may not appear.

The tele-converter lens 100-1 according to various embodiments may satisfy condition 1-2 obtained by modifying condition 1-1.

1.7<TT/1stY<1.9 (1-2)

The tele-converter lens 100-1 according to various embodiments may satisfy condition 2-1.

0<AT/LT<0.45 (2-1)

Here, AT denotes the sum of the distances between lenses included in the tele-converter lens 100-1 and LT denotes the sum of the thicknesses of the lenses included in the tele-converter lens 100-1. In other words, AT denotes the sum of a distance on the optical axis OA between the first lens L1-1 and the second lens L2-1, a distance on the optical axis OA between the second lens L2-1 and the third lens L3-1, and a distance on the optical axis OA between the third lens L3-1 and the fourth lens L4-1, and LT denotes the sum of the thickness of the first lens L1-1 on the optical axis OA, the thickness of the second lens L2-1 on the optical axis OA, the thickness of the third lens L3-2 on the optical axis OA, and the thickness of the fourth lens L4-1 on the optical axis OA.

Condition 2-1 represents limiting the ratio of the sum of the distances between the lenses constituting the tele-converter lens 100-1 to the sum of the thicknesses of the lenses. By reducing the distances between the lenses and suppressing the curvature of field, according to condition 2-1, the entire optical system may be miniaturized while maintaining a peripheral image quality performance.

The tele-converter lens 100-1 according to various embodiments may satisfy Equation 2-2 obtained by modifying condition 2-1.

0<AT/LT<0.3 (2-2)

The tele-converter lens 100-1 according to various embodiments may satisfy condition 3.

1.4≤TEFL/EFLD≤2.2 (3)

Here, EFLD denotes the focal length of the main photographing lens M and TEFL denotes the focal length of the entire optical system in which the tele-converter lens 100-1 is applied on the object side OBJ of the main photographing lens M.

A focal length that is about 1.4 times to about 2.2 times greater than the focal length of the main photographing lens M may be realized by applying the tele-converter lens 100-1.

The definition of the aspherical surface used in the tele-converter lenses 100-1, 100-2, and 100-3 according to various embodiments is as follows.

The shape of the aspheric surface may be expressed by Equation 4 with an optical axis direction as the x axis and a direction perpendicular to the optical axis direction as the y axis, assuming that the traveling direction of a light beam is positive.

$$x = \frac{{cy}^{2}}{1 + \sqrt{1 - ( K + 1 ) {c}^{2} {y}^{2}}} + {Ay}^{4} + {By}^{6} + {Cy}^{8} + {Dy}^{10} + … \qquad ( 4 )$$

Here, x denotes a distance from the vertex of a lens in the optical axis direction, y denotes a distance in a direction perpendicular to the optical axis direction, K denotes a conic constant, A, B, C, and D denotes aspheric coefficients, and c denotes the reciprocal of the radius of curvature at the vertex of the lens.

In the present disclosure, a tele-converter lens may be implemented by numerical examples according to various designs as follows.

In each of the numerical examples, lens surface numbers (1, 2, 3, . . . , Sn; n is a natural number) are sequentially assigned to lenses in series from an object side OBJ to an image plane IMG. An asterisk next to the lens surface numbers indicates that the surface is aspheric. nd denotes the refractive index, and vd denotes the Abbe number. The unit of Radius of Curvature, Thickness or Distance shown in each numerical example is in millimeters (mm).

### First Numerical Example

FIG. 1 illustrates the tele-converter lens 100-1 of the first numerical example according to various embodiments, and Table 1 shows, for example, the design data of the first numerical example.

TABLE 1

| Surface | Radius of | Thickness or | | |
|---|---|---|---|---|
| Number | Curvature | Distance | nd | Vd |
| 1 | 17.44 | 4.9663 | 1.516 | 64.2 |
| 2 | 22.359 | 0.2 | | |
| 3* | 14.485 | 6.584 | 1.531 | 55.91 |
| 4* | 36.88 | 0.847 | | |
| 5 | 291.972 | 8.85 | 1.8466 | 23.78 |
| 6 | 7.163 | 0.229 | | |
| 7* | 9.046 | 4.78 | 1.6428 | 22.4 |
| 8* | 38.536 | | | |

Table 2 shows aspherical surface coefficients in the first numerical example.

TABLE 2

| Surface Number | K | A | B | C | D |
|---|---|---|---|---|---|
| 3 | −0.36668 | −8.67E−05 | −8.46E−08 | 1.70E−09 | −2.55E−12 |
| 4 | −99 | −4.70E−05 | 4.31E−07 | 1.23E−09 | −1.16E−11 |
| 7 | 1.56758 | 9.79E−04 | −1.94E−05 | 4.36E−07 | 2.56E−09 |
| 8 | 92.18057 | 1.52E−03 | −1.06E−04 | 7.91E−06 | −1.44E−07 |

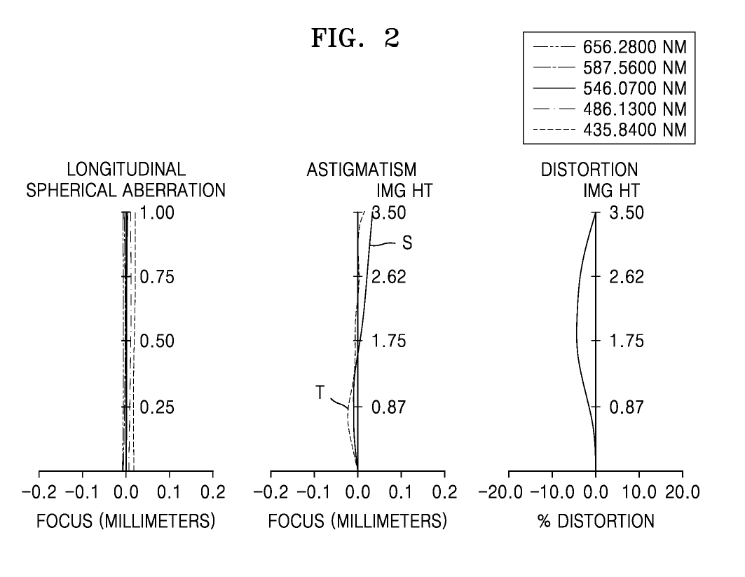

FIG. 2 illustrates longitudinal spherical aberration, astigmatism, and distortion of the tele-converter lens 100-1 according to the first numerical example. The longitudinal spherical aberration is shown, for example, for light having wavelengths of 656.2800 nanometers (NM), 587.5600 NM, 546.0700 NM, 486.1300 NM, and 435.8400 NM. The astigmatism shows a tangential field curvature (T) and a sagittal field curvature (S) for light having a wavelength of 587.5600 NM. The distortion is shown for light having a wavelength of 587.5600 NM.

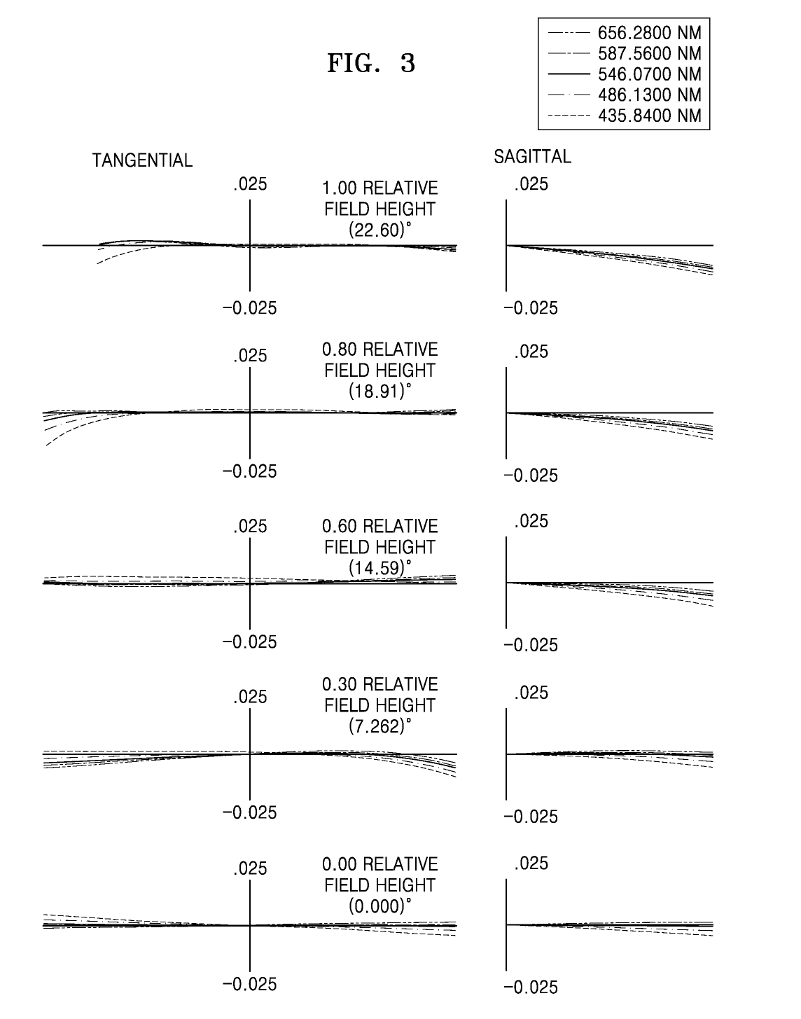

FIG. 3 illustrates transverse chromatic aberration of the tele-converter lens 100-1 according to the first numerical example. The transverse chromatic aberration is shown for light having wavelengths of 656.2800 NM, 587.5600 NM, 546.0700 NM, 486.1300 NM, and 435.8400 NM.

### Second Numerical Example

FIG. 4 illustrates the tele-converter lens 100-2 of the second numerical example according to various embodiments, and Table 3 shows, for example, the design data of the second numerical example.

TABLE 3

| Surface | Radius of | Thickness or | | |
|---|---|---|---|---|
| Number | Curvature | Distance | nd | Vd |
| 1 | 23.734 | 3.815 | 1.772 | 49.6 |
| 2 | 24.854 | 0.25 | | |
| 3* | 19.33 | 8.772 | 1.544 | 56.1 |
| 4* | 95.915 | 0.53 | | |
| 5* | 44.739 | 6.998 | 1.642 | 22.4 |
| 6* | 11.618 | 3.934 | | |
| 7 | 44.521 | 8.8 | 1.728 | 28.3 |
| 8 | −10.149 | 1.5 | 2.001 | 29.13 |
| 9 | −544.37 | | | |

Table 4 shows aspherical surface coefficients in the second numerical example.

TABLE 4

| Surface Number | K | A | B | C | D |
|---|---|---|---|---|---|
| 3 | −1.21977 | 1.58E−06 | 1.15E−08 | 5.23E−11 | 9.12E−14 |
| 4 | −7.20636 | 5.85E−06 | 2.63E−08 | 2.19E−11 | −3.25E−13 |
| 5 | −7.96762 | −7.74E−06 | −1.56E−09 | −4.89E−11 | 9.74E−15 |
| 6 | −2.79707 | −3.17E−05 | −2.82E−07 | −7.29E−10 | 6.27E−12 |

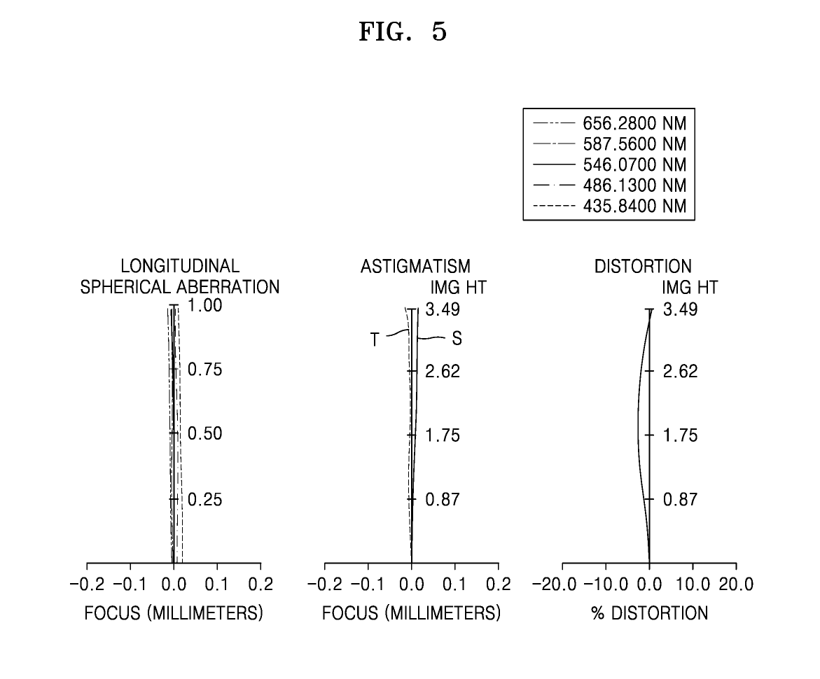

FIG. 5 illustrates longitudinal spherical aberration, astigmatism, and distortion of the tele-converter lens 100-2 according to the second numerical example.

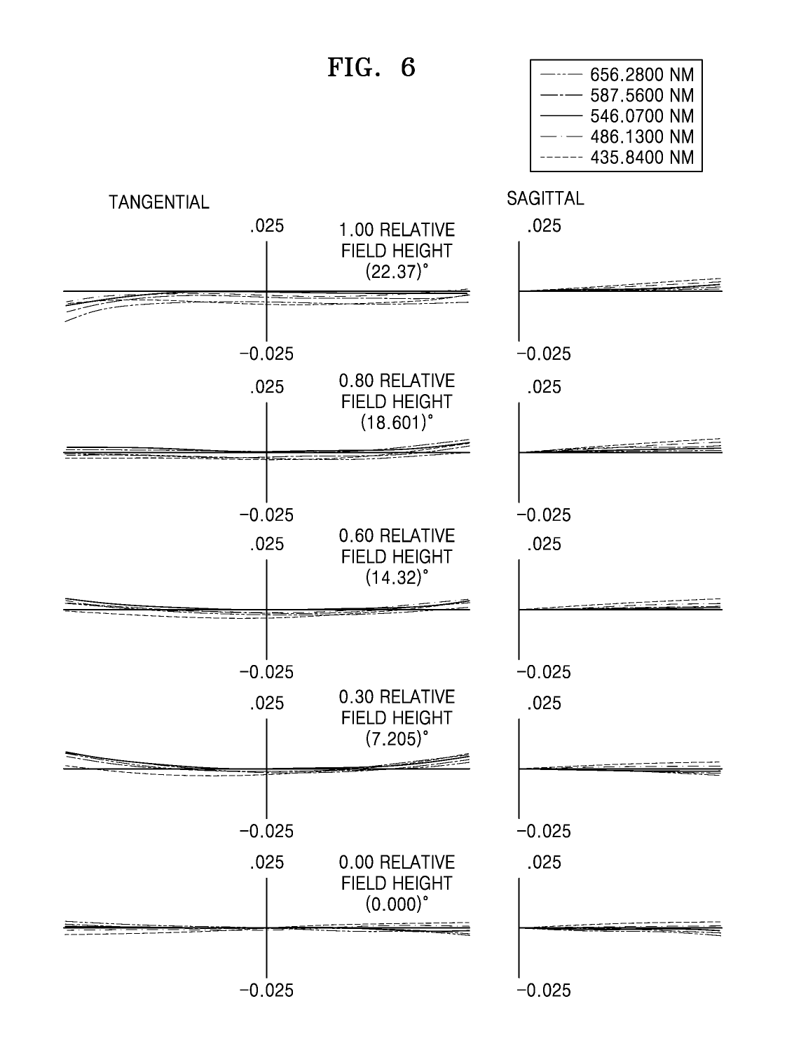

FIG. 6 illustrates transverse chromatic aberration of the tele-converter lens 100-2 according to the second numerical example.

### Third Numerical Example

FIG. 7 illustrates the tele-converter lens 100-3 of the third numerical example according to various embodiments, and Table 5 shows, for example, the design data of the third numerical example.

TABLE 5

| Surface | Radius of | Thickness or | | |
|---|---|---|---|---|
| Number | Curvature | Distance | nd | Vd |
| 1 | 16.89 | 7.6 | 1.5891 | 61.25 |
| 2 | 83.298 | 1.267 | | |
| 3* | 26.919 | 4.5 | 1.6428 | 22.39 |
| 4* | 13.253 | 2.305 | | |
| 5 | 17.616 | 5.659 | 1.7847 | 25.72 |
| 6 | −17.616 | 0.8 | 2.001 | 29.13 |
| 7 | 5.78 | 0.852 | | |
| 8 | 7.303 | 1.59 | 1.58144 | 40.59 |
| 9 | −80.428 | | | |

Table 6 shows aspherical surface coefficients in the third numerical example.

TABLE 6

| Surface | | | | | |
|---|---|---|---|---|---|
| Number | K | A | B | C | D |
| 3 | −16.1641 | −1.48E−04 | 8.55E−07 | −3.16E−09 | 5.39E−12 |
| 4 | −9.32523 | −1.50E−04 | 3.37E−07 | 3.04E−10 | |

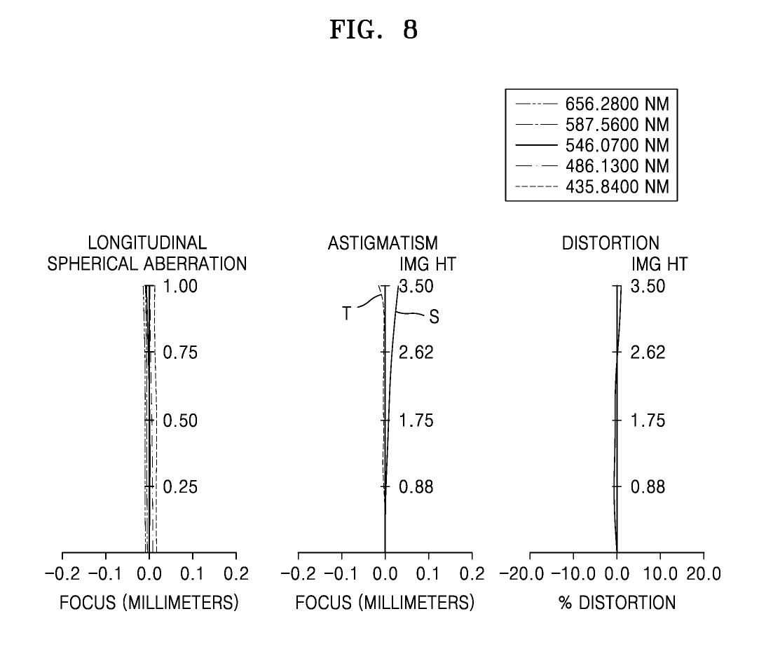

FIG. 8 illustrates longitudinal spherical aberration, astigmatism, and distortion of the tele-converter lens 100-3 according to the third numerical example.

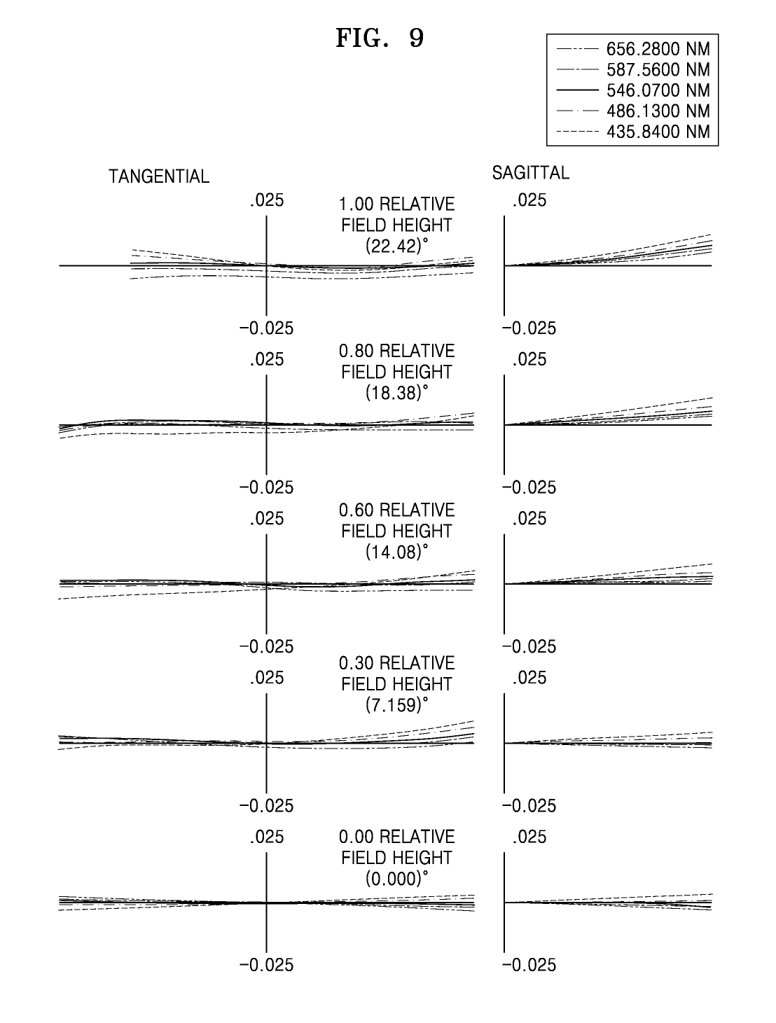

FIG. 9 illustrates transverse chromatic aberration of the tele-converter lens 100-3 according to the third numerical example.

Table 7 shows optical specifications, such as the total thickness TT on the optical axis of each of the tele-converter lens 100-1, 100-2, and 100-3 according to the first to third numerical examples, the effective diameter 1stY of the first lens on the object side, the sum AT of the distances between lenses included in each of the tele-converter lens 100-1, 100-2, and 100-3, the sum LT of the thicknesses of the lenses, and focal lengths f1, f2, f3, f4, and f5 of the lenses. The units of numerical values shown in Table 7 are in millimeters (mm).

TABLE 7

| | First | Second | Third |
|---|---|---|---|
| | Example | Example | Example |
| TT | 26.46 | 34.6 | 24.57 |
| 1stY | 14.52 | 19.7 | 13.86 |
| AT | 1.28 | 4.71 | 4.42 |
| LT | 25.18 | 29.89 | 20.15 |
| f1 | 113.64 | 272.68 | 34.36 |
| f2 | 40.57 | 42.58 | −46.18 |
| f3 | −8.71 | −26.36 | 11.97 |
| f4 | 17.11 | 12.08 | −4.24 |
| f5 | | −10.26 | 11.52 |

Table 8 shows that the tele-converter lenses 100-1, 100-2, and 100-3 according to the first to third numerical examples satisfies the above-described conditions.

TABLE 8

| | First | Second | Third |
|---|---|---|---|
| Condition | Example | Example | Example |
| 1.5 < TT/1stY < 2.0 | 1.822 | 1.756 | 1.773 |
| AT/LT < 0.45 | 0.051 | 0.158 | 0.22 |
| 1.4 < TEFL/EFLD < 2.2 | 1.94 | 1.96 | 1.93 |

The tele-converter lenses 100-1, 100-2, and 100-3 according to various embodiments may be applied to, for example, photographing apparatuses employing image sensors and electronic devices including the photographing apparatuses. The tele-converter lenses 100-1, 100-2, and 100-3 according to various embodiments is applicable to various electronic devices such as a digital camera, an interchangeable lens camera, a video camera, a mobile phone camera, and a camera for a small-sized mobile device.

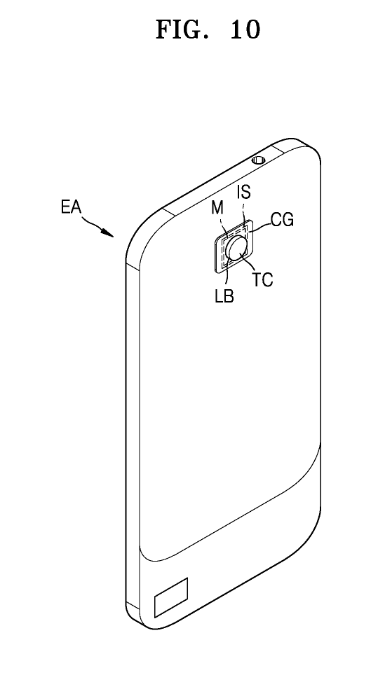

FIG. 10 is a diagram illustrating an example of an electronic device EA including a tele-converter lens according to an example embodiment. FIG. 10 illustrates an example, in which the electronic device EA is a mobile phone, but various embodiments are not limited thereto.

The electronic device EA is for photographing an image of an object and may include a main photographing lens M having one or more lenses, a tele-converter lens TC mounted on the main photographing lens M, and an image sensor IS that receives an image formed by the main photographing lens M and the tele-converter lens TC and converts the image into an electrical image signal. The main photographing lens M and the image sensor IS may be located in the electronic device EA, and a lens barrel LB on which the tele-converter lens TC is mounted may be mounted on a cover glass CG located on the outer surface of the electronic device EA.

The tele-converter lens TC may be one of the tele-converter lenses 100-1, 100-2, and 100-3 according to various embodiments described above with reference to FIGS. 1 to 9. When the tele-converter lens according to various embodiments is applied to a small-sized digital camera, and a photographing device of a mobile phone, etc., a photographing apparatus capable of photographing at an increased magnification while maintaining existing optical performances such as resolution and brightness may be implemented.

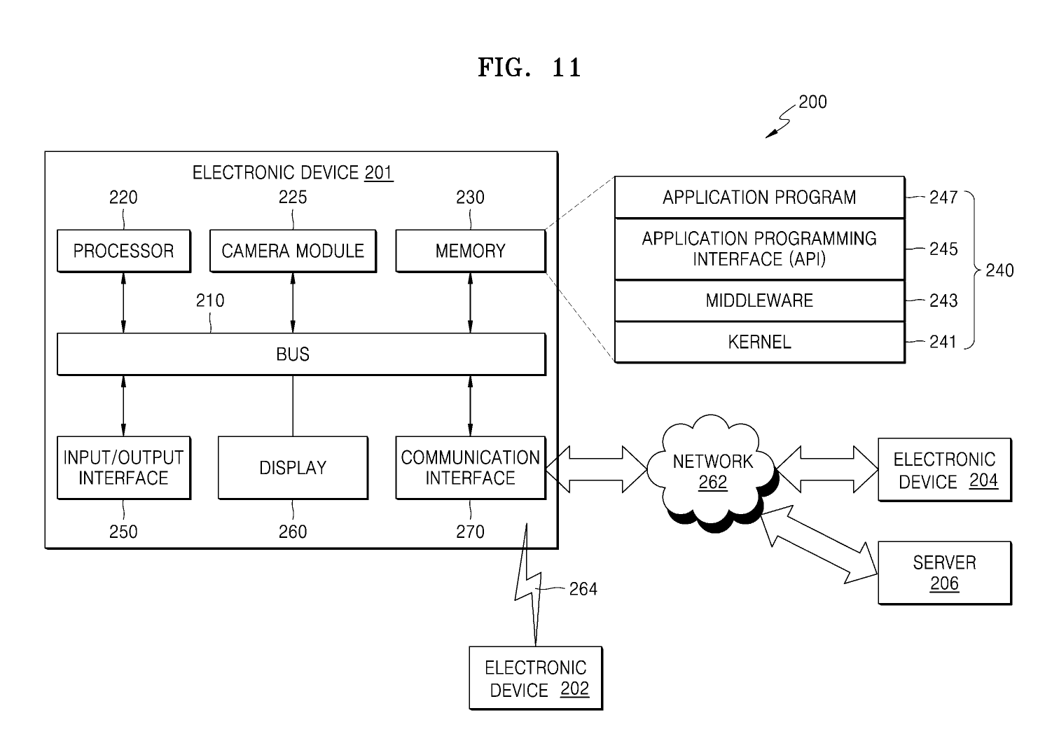

An electronic device 201 in a network environment 200 according to various embodiments will be described below with reference to FIG. 11. The electronic device 201 may include a bus 210, a processor 220, a camera module 225, a memory 230, an input/output interface 250, a display 260, and a communication interface 270. In some embodiments, the electronic device 201 may omit at least one of the components, or may further include an additional component.

The bus 210 may include, for example, a circuit connecting the components (210 to 270) to one another and transmitting communication (e.g., a control message and/or data) among the components.

The processor 220 may include at least one of a central processing unit (CPU), an application processor (AP), and a communication processor (CP). The processor 220 may execute, for example, calculations or data processing about controlling and/or communicating among at least one another component in the electronic device 201.

The camera module 225 is, for example, a device capable of capturing still images and videos, and according to an example embodiment, the camera module 225 may include one or more image sensors (e.g., a front sensor or a rear sensor), a lens, an image signal processor (ISP), or a flash (e.g., a light emitting diode (LED), a xenon lamp, etc.) For example, the tele-converter lens according to various embodiments may be applied to the camera module 225.

The memory 230 may include a volatile and/or non-volatile memory. The memory 230 may store, for example, instructions or data regarding at least one another component in the electronic device 201. According to one example embodiment, the memory 230 may store software and/or a program 240. The program 240 may include, for example, a kernel 241, middleware 243, an application programming interface (API) 245, and/or an application program (or “application”) 247, etc. At least some of the kernel 241, the middleware 243, or the API 245 may be referred to as an operating system (OS).

The kernel 241 may control or manage system resources (e.g., the bus 210, the processor 220, the memory 230, etc.) used to execute operations or functions implemented in other programs (e.g., the middleware 243, the API 245, or the application program 247). Also, the kernel 241 may provide an interface capable of controlling or managing the system resources, by accessing individual component of the electronic device 201 from the middleware 243, the API 245, or the application program 247.

The middleware 243 may perform mediation function so that, for example, the API 245 or the application program 247 may communicate with the kernel 241 and exchange data.

In addition, the middleware 243 may process one or more operation requests transmitted from the application program 247 according to a priority order. For example, the middleware 143 may grant to at least one of the application program 247 a priority order of using the system resources (e.g., the bus 210, the processor 220, or the memory 230) of the electronic device 201. For example, the middleware 243 processes the one or more operation requests according to the priority order granted to the at least one application program 247, thereby performing scheduling or load balancing of the one or more operation requests.

The API 245 is, for example, an interface for the application 247 to control the functions provided by the kernel 241 or the middleware 243, and may include at least one interface or function (e.g., instruction), for example, for file control, window control, image processing, or text control.

The input/output interface 250 may function as, for example, an interface capable of transmitting instruction or data input from the user or another external device to the other component(s) of the electronic device 201. In addition, the input/output interface 250 may output instruction or data transmitted from the other component(s) of the electronic device 201 to the user or another external device.

The display 260 may include, for example, a liquid crystal display (LCD), a light-emitting diode (LED) display, an organic light-emitting diode (OLED) display, a microelectromechanical systems (MEMS) display, or an electronic paper display. The display 260 may display, for example, various pieces of content (e.g., text, images, videos, icons, or symbols) to the user. The display 260 may include a touch screen, and may receive, for example, a touch input, a gesture input, a proximity input, or a hovering input via an electronic pen or a part of a body of the user.

The communication interface 270 may set communications between, for example, the electronic device 201 and an external device (e.g., a first external electronic device 202, a second external electronic device 204, or a server 206). For example, the communication interface 270 is connected to a network 262 via wireless communication or wires communication to communicate with an external device (e.g., the second external electronic device 204 or the server 206).

The wireless communication may use a cellular communication protocol, for example, at least one of long-term evolution (LTE), LTE-advance (LTE-A), code division multiple access (CDMA), wideband CDMA (WCDMA), universal mobile telecommunications system (UMTS), wireless broadband (WiBro), and global system for mobile communications (GSM). Also, the wireless communication may include, for example, near distance communication 264. The near distance communication 264 may include, for example, at least one of wireless fidelity (WiFi), Bluetooth, near field communication (NFC), and global navigation satellite system (GNSS). GNSS may include, for example, at least one of global positioning system (GPS), global navigation satellite system (Glonass), Beidou navigation satellite system (Beidou) or Galileo, and the European global satellite-based navigation system, according to used region or bandwidth. Hereinafter, in the present specification, GPS and GNSS may be interchangeably used. The wires communication may include, for example, at least one of universal serial bus (USB), high definition multimedia interface (HDMI), recommended standard-232 (RS-232), and plain old telephone service (POTS). The network 262 may include telecommunications network, for example, at least one of computer network (e.g., LAN or WAN), Internet, and telephone network.

The first and second external electronic devices 202 and 204 may each be a device of the same kind as or different from the electronic device 201. According to one embodiment, the server 206 may include a group of one or more servers. According to various embodiments, all or some of operations performed in the electronic device 201 may be executed in one or more other electronic devices (e.g., the electronic devices 202 and 204), or the server 206. According to one example embodiment, in a case where the electronic device 201 has to perform a certain function or service automatically or upon request, the electronic device 201 may request another device (e.g., the electronic devices 202 and 204, or the server 206) to perform at least some functions related to the certain function or service, instead of or additionally to the executing of the certain function or service on its own. The electronic device (e.g., the electronic devices 202 and 204, or the server 206) may execute requested function or the additional function, and may transfer a result of execution to the electronic device 201. The electronic device 201 may provide requested function or service after processing or without processing the result. To do this, for example, a cloud computing, a distributed computing, or a client-server computing technique.

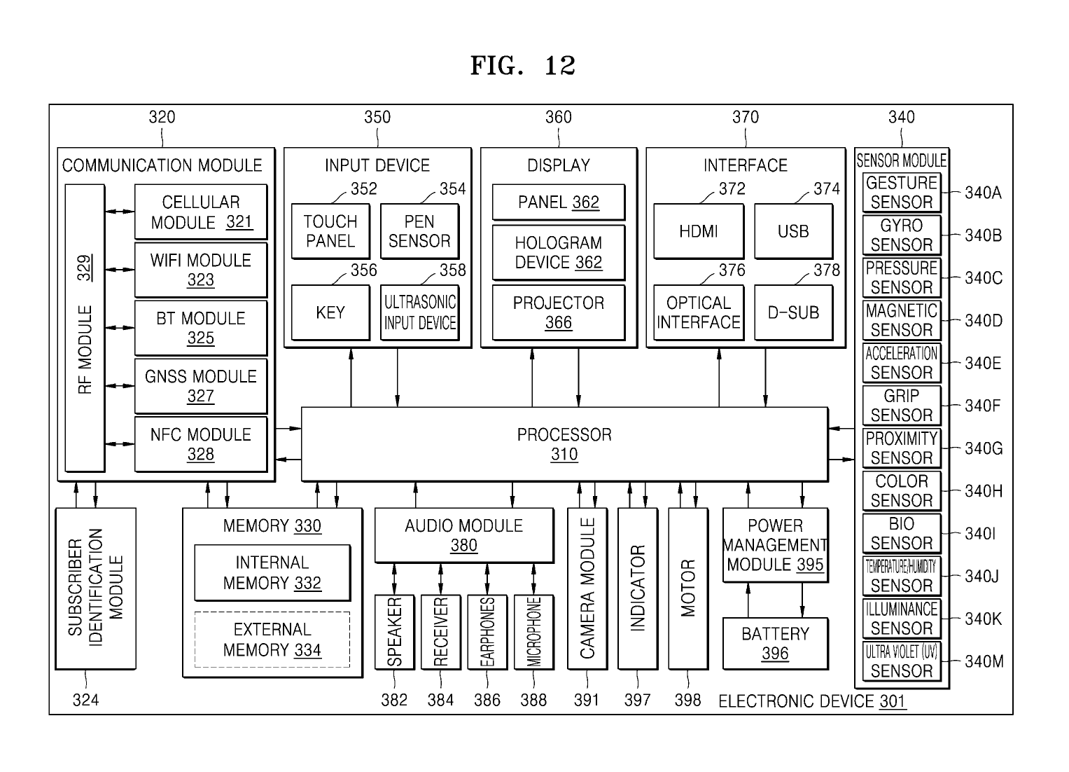

FIG. 12 is a block diagram of an electronic device 301 according to various embodiments. The electronic device 301 may include, for example, whole or some parts of the electronic device 201 illustrated in FIG. 11. The electronic device 301 may include one or more processors (e.g., an application processor (AP)) 310, a communication module 320 (a subscriber identification module 324), a memory 330, a sensor module 340, an input device 350, a display 360, an interface 370, an audio module 380, a camera module 391, a power management module 395, a battery 396, an indicator 397, and a motor 398.

The processor 310 may drive, for example, an operating system or an application program to control a plurality of hardware or software components connected to the processor 310, and may perform various data processing and calculation. The processor 310 may be implemented as, for example, a system on chip (SOC). According to one embodiment, the processor 310 may further include a graphic processing unit (GPU) and/or an image signal processor. The processor 310 may load the instruction or data transmitted from at least one of the other components (e.g., non-volatile memory) on a volatile memory to process the instruction or data, and may store various data in the non-volatile memory.

The communication module 320 may have a structure that is the same as or similar to that of the communication interface 270 of FIG. 11. The communication module 320 may include, for example, a cellular module 321, a WiFi module 323, a Bluetooth module 325, a GNSS module 327 (e.g., a GPS module, a Glonass module, a Beidou module, or a Galileo module), an NFC module 328, and a radio frequency (RF) module 329.

The cellular module 321 may provide, for example, voice call service, video call service, text message service, or Internet service via a communication network. According to one example embodiment, the cellular module 321 may perform discrimination and authentication of the electronic device 301 within the communication network by using the subscriber identification module (e.g., a SIM card) 324. According to one example embodiment, the cellular module 321 may perform at least some of the functions that may be provided by the processor 310. According to one example embodiment, the cellular module 321 may include a communication processor (CP).

Each of the WiFi module 323, the Bluetooth module 325, the GNSS module 327, and the NFC module 328 may include a processor for processing data transmitted/received through the corresponding module. According to one example embodiment, at least some (e.g., two or more) of the cellular module 321, the WiFi module 323, the Bluetooth module 325, the GNSS module 327, and the NFC module 328 may be included in one integrated chip (IC) or an IC package.

The RF module 329 may transmit/receive, for example, a communication signal (e.g., an RF signal). The RF module 329 may include, for example, a transceiver, a power amp module (PAM), a frequency filter, a low noise amplifier (LNA), or an antenna. According to another example embodiment, at least one of the cellular module 221, the WiFi module 323, the Bluetooth module 325, the GNSS module 327, and the NFC module 328 may transmit/receive an RF signal via an additional RF module.

The subscriber identification module 324 may include, for example, a card including the subscriber identification module and/or an embedded SIM, and may include unique identification information (e.g., integrated circuit card identifier (ICCID)) or subscriber information (e.g., international mobile subscriber identity (IMSI)).

The memory 330 may include, for example, an internal memory 332 or an external memory 334. The internal memory 332 may include, for example, at least one of a volatile memory (e.g., dynamic RAM (DRAM), static RAM (SRAM), synchronous dynamic RAM (SDRAM), etc.), a non-volatile memory (e.g., one time programmable ROM (OTPROM), programmable ROM (PROM), an erasable and programmable ROM (EPROM), an electrically erasable and programmable ROM (EEPROM), a mask ROM, a flash ROM, a flash memory (e.g., NAND flash, NOR flash, etc.), hard drive, or solid state drive (SSD).

The external memory 334 may further include a flash drive, for example, a compact flash (CF), secure digital (SD), micro-SD, Mini-SD, extreme digital (xD), a multi-media card (MMD), a memory stick, etc. The external memory 334 may be functionally and/or physically connected to the electronic device 301 via various interfaces.

The sensor module 340 may measure a physical amount or sense an operating state of the electronic device 301, so as to convert measured or sensed information into an electric signal. The sensor module 340 may include, for example, at least one of a gesture sensor 340A, a gyro sensor 340B, an atmospheric pressure sensor 340C, a magnetic sensor 340D, an acceleration sensor 340E, a grip sensor 340F, a proximity sensor 340G, a color sensor 340H (e.g., a red, green, blue (RGB) sensor), a bio sensor 340I, a temperature/humidity sensor 340J, an illuminance sensor 340K, and an ultra violet (UV) sensor 340M. Additionally or alternatively, the sensor module 340 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 340 may include a control circuit for controlling at least one sensor included therein. In some embodiments, the electronic device 301 may further include a processor configured to control the sensor module 340 as a part of the processor 310 or separately, so as to control the sensor module 340 while the processor 310 is in a sleep state.

The input device 350 may include, for example, a touch panel 352, a (digital) pen sensor 354, a key 356, or an ultrasonic input device 358. The touch panel 352 may use at least one of, for example, a capacitive type, a pressure sensitive type, an IR type, and an ultrasound type touch screen. Also, the touch panel 352 may further include a control circuit. The touch panel 352 may further include a tactile layer to provide a user with a tactile reaction.

The (digital) pen sensor 354 may be, for example, a part of the touch panel 352, or may include an additional recognition sheet. The key 356 may include, for example, a physical button, an optical key, or a keypad. The ultrasound input device 358 may sense ultrasound wave generated from an input device via a microphone (e.g., a microphone 388) to identify data corresponding to the ultrasound wave.

The display 360 (e.g., the display 360) may include a panel 362, a hologram device 364, or a projector 366. The panel 362 may have a structure that is the same as or similar to that of the display 260 shown in FIG. 11. The panel 362 may be configured to be, for example, flexible, transparent, or wearable. The panel 362 may be configured as one module with the touch panel 352. According to one example embodiment, the panel 362 may include a pressure sensor (or a force sensor) capable of measuring an intensity of a pressure from a touch of the user. The pressure sensor may be provided integrally with the touch panel 352, or may be provided as one or more additional sensors separately from the touch panel 352. The hologram device 364 may show a stereoscopic image in the air by using interference of light. The projector 366 may display images by projecting light onto a screen. The screen may be located, for example, inside or outside the electronic device 301. According to one example embodiment, the display 360 may further include a control circuit for controlling the panel 362, the hologram device 364, or the projector 366.

The interface 370 may include, for example, an HDMI 372, a universal serial bus (USB) 374, an optical interface 376, or a D-subminiature (D-sub) 378. The interface 370 may be included, for example, in the communication interface 270 shown in FIG. 11. Additionally or alternatively, the interface 370 may include, for example, a mobile high-definition link (MHL) interface, a secure digital (SD) card/multi-media card (MMC) interface, or infrared data association (IrDA) standard interface.

The audio module 380 may bi-directionally convert sound and electric signals to each other. At least some of components of the audio module 380 may be included in, for example, an input/output interface 245 shown in FIG. 10. The audio module 380 may process sound information input or output through, for example, a speaker 382, a receiver 384, earphones 386, or a microphone 388.

The camera module 391 is, for example, a device capable of capturing still images and videos, and according to an example embodiment, the camera module 225 may include one or more image sensors (e.g., a front sensor or a rear sensor), a lens, an image signal processor (ISP), or a flash (e.g., a light emitting diode (LED), a xenon lamp, etc.) For example, the tele-converter lens according to various embodiments may be applied to the camera module 391.

The power management module 395 may manage power of the electronic device 301. The electronic device 301 may be an electronic device receiving power supply from a battery, but is not limited thereto. According to one example embodiment, the power management module 395 may include a power management integrated circuit (PMIC), a charger IC, or a battery or fuel gauge. The PMIC may be charged through wires and/or wirelessly. The wireless charging method may include, for example, a magnetic resonance method, a magnetic induction method, or an electromagnetic wave method, and an additional circuit for wireless charging, for example, a coil loop, a resonant circuit, or a rectifier may be further provided. The battery gauge may measure, for example, a remaining capacity of the battery 396, a voltage, a current, or a temperature during the charging. The battery 396 may include, for example, a rechargeable battery and/or a solar battery.

The indicator 397 may display a certain state of the electronic device 301 or a part of the electronic device 301 (e.g., the processor 310), for example, a booting state, a message state, or a charging state. The motor 398 may convert an electric signal into mechanical vibration, and may generate vibration effect or haptic effect. Although not shown in the drawing, the electronic device 301 may include a processing device (e.g., GPU) for supporting mobile TV function. The processing device for supporting the mobile TV may process media data according to standard such as digital multimedia broadcasting (DMB), digital video broadcasting (DVB), or mediaFlo™.

The tele-converter lens according to various embodiments, which is a tele-converter lens mounted at the object side of a main photographing lens, includes: a first lens having a positive refractive power; a second lens having a refractive power and having at least one aspherical surface; and at least one lens having a refractive power, wherein the first lens, the second lens, and the at least one lens are sequentially arranged from the object side toward the main photographing lens.

For example, the tele-converter lens may satisfy the following condition.

1.5<TT/1stY<2.0

Here, TT denotes the total thickness on an optical axis of the tele-converter lens and 1stY denotes the effective diameter of the first lens.

For example, the tele-converter lens may satisfy the following condition.

0<AT/LT<0.45

Here, AT denotes the sum of the distances between lenses included in the tele-converter lens and LT denotes the sum of the thicknesses of the lenses included in the tele-converter lens.

For example, the tele-converter lens may satisfy the following condition.

1.4≤TEFL/EFLD≤2.2

Here, EFLD denotes the focal length of the main photographing lens and TEFL denotes the focal length of the entire optical system including the tele-converter lens and the main photographing lens.

For example, the first lens may have a meniscus shape of which object side surface is convex.

For example, the material of the second lens may include a plastic resin.

For example, the second lens may have a positive refractive power.

For example, the second lens may have a meniscus shape of which object side surface is convex.

For example, the at least one lens may include: a third lens having a negative refractive power, and a fourth lens having a positive refractive power.

For example, the third lens may have a concave surface toward the main photographing lens, and the object side surface of the fourth lens may be convex.

For example, the at least one lens may further include a fifth lens located between the fourth lens and the main photographing lens, the fifth lens having a negative refractive power.

For example, the fourth lens may have a convex surface toward the main photographing lens, and the object side surface of the fifth lens may be concave.

For example, the fourth lens and the fifth lens may be cemented to each other to form a cemented lens.

For example, the second lens may have a negative refractive power.

For example, the at least one lens may include: a third lens having a positive refractive power, a fourth lens having a negative refractive power, and a fifth lens having a positive refractive power.

For example, the third lens may be in a biconvex shape, and the fourth lens may be in a biconcave shape.

For example, the third lens and the fourth lens may be cemented to each other to form a cemented lens.

An electronic device according to various embodiments includes: a photographing lens including at least one lens; a tele-converter lens mounted at an object side of the photographing lens, the tele-converter lens including a first lens having a positive refractive power, a second lens having a refractive power and having at least one aspheric surface, and at least one lens having a refractive power, wherein the first lens, the second lens, and the at least one lens are sequentially arranged from the object side toward the photographing lens; and an image sensor configured to convert an optical image formed by an optical system including the tele-converter lens and the photographing lens into an electrical signal.

For example, the electronic device may satisfy the following conditions.

1.5<TT/1stY<2.0

0<AT/LT<0.45

Here, TT denotes the total thickness on an optical axis of the tele-converter lens, 1stY denotes the effective diameter of the first lens, AT denotes the sum of the distances between lenses included in the tele-converter lens, and LT denotes the sum of the thicknesses of the lenses included in the tele-converter lens.

For example, the electronic device may satisfy the following condition.

1.4≤TEFL/EFLD≤2.2

Here, EFLD denotes the focal length of the main photographing lens and TEFL denotes the focal length of the entire optical system including the tele-converter lens and the photographing lens.

Each of the aforementioned components of the electronic device may include one or more parts, and a name of the part may vary with a type of the electronic device. The electronic device in accordance with various embodiments may include at least one of the aforementioned components, omit some of them, or include other additional components. Some of the components may be combined into an entity, but the entity may perform the same functions as the components may do.

The term “module” used herein may refer to a unit including one of hardware, software, and firmware, or a combination thereof. The term “module” may be interchangeably used with a unit, logic, logical block, component, or circuit. The “module” may be a minimum unit or part of an integrated component. The “module” may be a minimum unit or part of performing one or more functions. The “module” may be implemented mechanically or electronically. For example, the “module” may include at least one of application specific integrated circuit (ASIC) chips, field programmable gate arrays (FPGAs), or programmable logic arrays (PLAs) that perform some operations, which have already been known or will be developed in the future.

According to various embodiments, at least a part of the apparatus (e.g., modules or their functions) or method (e.g., operations) may be implemented as instructions stored in a computer-readable storage medium e.g., in the form of a program module. The instructions, when executed by a processor (e.g., the processor 220 of FIG. 11), may enable the processor to carry out a corresponding function. The computer-readable storage medium may be e.g., the memory 230.

The computer-readable storage medium may include a hardware device, such as hard discs, floppy discs, and magnetic tapes (e.g., a magnetic tape), optical media such as compact disc read only memories (ROMs) (CD-ROMs) and digital versatile discs (DVDs), magneto-optical media such as floptical disks, ROMs, random access memories (RAMs), flash memories, or the like. Examples of the program instructions may include not only machine language codes but also high-level language codes which are executable by various computing means by using an interpreter. The aforementioned hardware devices may be configured to operate as one or more software modules to carry out exemplary embodiments, and vice versa. Modules or programming modules in accordance with various exemplary embodiments may include at least one or more of the aforementioned components, omit some of them, or further include other additional components. Operations performed by modules, programming modules or other components in accordance with various embodiments may be carried out sequentially, simultaneously, repeatedly, or heuristically. Furthermore, some of the operations may be performed in a different order, or omitted, or include other additional operation(s). It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

1. A tele-converter lens mounted at an object side of a main photographing lens, the tele-converter lens comprising:
a first lens having a positive refractive power;
a second lens having a refractive power and having at least one aspherical surface; and
at least one lens having a refractive power,
wherein the first lens, the second lens, and the at least one lens are sequentially arranged from the object side toward the main photographing lens.

2. The tele-converter lens of claim 1, satisfying the following condition:
1.5<TT/1stY<2.0,
where TT denotes a total thickness on an optical axis of the tele-converter lens and 1stY denotes an effective diameter of the first lens.

3. The tele-converter lens of claim 1, satisfying the following condition:
0<AT/LT<0.45,
where AT denotes a sum of distances between lenses included in the tele-converter lens and LT denotes a sum of thicknesses of the lenses included in the tele-converter lens.

4. The tele-converter lens of claim 1, satisfying the following condition:
1.4≤TEFL/EFLD≤2.2
where EFLD denotes a focal length of the main photographing lens and TEFL denotes a focal length of an entire optical system including the tele-converter lens and the main photographing lens.

5. The tele-converter lens of claim 1, wherein the first lens has a meniscus shape of which object side surface is convex.

6. The tele-converter lens of claim 1, wherein a material of the second lens comprises a plastic resin.

7. The tele-converter lens of claim 1, wherein the second lens has a positive refractive power and has a meniscus shape of which object side surface is convex.

8. The tele-converter lens of claim 7, wherein the at least one lens comprises:
a third lens having a negative refractive power; and
a fourth lens having a positive refractive power.

9. The tele-converter lens of claim 8, wherein the third lens has a concave surface toward the main photographing lens, and an object side surface of the fourth lens is convex.

10. The tele-converter lens of claim 8, wherein the at least one lens further comprises a fifth lens located between the fourth lens and the main photographing lens, the fifth lens having a negative refractive power.

11. The tele-converter lens of claim 10, wherein the fourth lens has a convex surface toward the main photographing lens and an object side surface of the fifth lens is concave,
wherein the fourth lens and the fifth lens are cemented to each other to form a cemented lens.

12. The tele-converter lens of claim 1, wherein the second lens has a negative refractive power.

13. The tele-converter lens of claim 12, wherein the at least one lens comprises:
a third lens having a positive refractive power;
a fourth lens having a negative refractive power; and
a fifth lens having a positive refractive power.

14. The tele-converter lens of claim 13, wherein the third lens has a biconvex shape and the fourth lens has a biconcave shape,
wherein the third lens and the fourth lens are cemented to each other to form a cemented lens.

15. An electronic device comprising:
a photographing lens including at least one lens;
a tele-converter lens according to claim 1, the tele-converter lens being located at an object side of the photographing lens; and
an image sensor configured to convert an optical image formed by an optical system including the tele-converter lens and the photographing lens into an electric signal.
